(19) United States
(12) Patent Application Publication
(10) Pub. No.: US 2004/0201600 A1
(43) Pub. Date: Oct. 14, 2004

(54) Methods and system for providing an XML-based interface description language

(75) Inventors: GopalaKrishna Reddy Kakivaya, Sammamish, WA (US); Savithri Dani, Issaquah, WA (US); Michael J. Toutonghi, Bellevue, WA (US)

Correspondence Address: Thomas E. Watson, Woodcock Washburn LLP, 46th Floor, One Liberty Place, Philadelphia, PA, 19103, US

(73) Assignee: Microsoft Corporation

(21) Appl. No.: 10/017,265

(22) Filed: Dec. 14, 2001

(51) Int. Cl. G09G 5/00

(52) U.S. Cl. 345/700; 715/513

(57) ABSTRACT

Type Description Language (TDL) is provided which is an extensible markup language (XML) based language that provides an interface description that makes the mapping between an interface specification and its wire format deterministic and simple. TDL provides seamless bridging between XML and object based views in a distributed environment. TDL leverages the duality between the type-based (objects) and XML-based views and may be used for exchanging metadata between various kinds of type (object) systems, such as Component Object Model (COM), Common Object Request Broker Architecture (CORBA), Common Language Runtime (CLR), etc. In this regard, TDL proposes a new syntax for representing the behavior aspect of a type and illustrates that there is a one to one mapping from an abstract type to a schema type and vice-versa.

### COPYRIGHT NOTICE PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document Copyright© 2000, Microsoft Corp.

### FIELD OF THE INVENTION

The present invention relates to the provision of an extensible markup language (XML) based Interface Description Language for use in a distributed computing environment. More particularly, the present invention relates to an XML-based language that enables seamless bridging between XML-based and Object-based, or Type-based, views in a distributed computing environment.

### BACKGROUND OF THE INVENTION

In peer to peer, or other distributed computing environments, typically there is complex interaction among a plurality of computing devices. Such interactions may include the exchange of data, such as the transmitting of information to another computing device, the transmitting of a request for action by a computing device, the transmitting of a request for notification of a property of another computing device, the transmitting of eventing information, the transmitting of tracking information, and so on. Generally, each of the computing devices also has at least one service that may be offered to other computing devices. While a service may concretely be thought of in terms of a stock notification service, a search engine service, or a weather service, a service may be broadly thought of as any type of action, processing or information exchange in a computing system that serves a useful purpose. For instance, a television offers audio volume altering services, brightness display altering services, etc. A software object may offer tracking, event notification, or property notification services for other software objects to use. In short, there are a myriad of services that a plurality of data objects and computing devices can offer one another in a distributed computing environment. While XML provides an extremely useful and powerful mechanism for the exchange of mere data from one computing device to another computing device, XML alone does not enable one computing device to communicate with another computing device in terms of the services offered thereby and/or the behavioral, or functional object, aspects thereof.

In an ideal distributed computing environment, a service would easily present itself to its clients, either automatically or by client request, in terms of the actions it can perform and the data it needs to send or receive in order to perform them, and according to what rules the clients need to follow to achieve the action and proper sending or receiving of the data. These presentations by services, also known as interface contracts, enable clients to classify services and communicate with them. Then, interoperability between service(s) and their client(s) is achieved by using wire format(s) derived from the interface specification(s). An ideal language for interface description would make the mapping between an interface specification and its wire format deterministic, simple and obvious; however, currently no such ideal language exists and thus there is a need for such an interface description language.

While a present day developer could write an XML Schema type that defines a service, ultimately, there is no convention that standardizes the Schema type. Thus, presently, two different developers could write Schema types that adequately define the same service, but the two different Schema types may nonetheless be different. Consequently, there is a need for a mechanism that provides a bridge, or structured framework, between an XML Schema and the object or type it structures, and vice versa. While an individually designed XML Schema may be effectively implemented as between two known computing devices, as the number of computing devices and services offered thereby increases, as in an arbitrarily large peer to peer system, present XML Schema type definitions are inadequate. Thus, since there is no standard way of presenting an XML Schema for a type or object, present XML Schema development is limited for purposes of implementations in a mass distributed computing environment.

Additionally, and more generally, because interface definitions may be written in a variety of fashions, there are ultimately a variety of wire protocols that may be used to transmit instances of the type or object back and forth between computing devices. For example, power line carrier (PLC), transport control protocol/internet protocol (TCP/IP), hypertext transfer protocol (HTTP), and so on all represent different wire protocols that may be used to package data for transfer between computing devices. When a variety of wire protocols may be used to transmit an interface definition, the process becomes even further non-standard. In the ideal distributed computing environment described above, a computing device is not concerned with wire format. Indeed, ideally, the interface definition language used to drive the standardization of interface definitions for services also serves to drive the wire format utilized. Thus, there is also a need in the art for an interface description language that also serves as a wire format for standard exchange of interface definitions among computing devices.

It would be desirable for such an interface description language to include expressibility, abstraction, precision, extensibility, modularity, usage and reuse. With respect to expressibility, it would be desirable for an expressive specification of an action to include sufficient information about all of the parts of the action signature. An expressive specification of related data types should support notions like sub-typing. It would also be useful to use a generic notion of a type system as a starting point for the definition of the language. Also, particularly for a distributed computing environment, it should be possible to specify the protocol binding for a service's actions. Thus, it would be further desirable for such an interface description language to include constructs for specifying different kinds of binding e.g., Simple Object Access Protocol (SOAP), Simple Mail Transfer Protocol (SMTP), etc.

With respect to abstraction, it would be desirable for such an interface description language to abstract the first-class concepts of the environment in which it operates as first-class primitives. Thus, it would be further desirable to add elements that encapsulate primitive concepts specific to particular operating environments, such as a peer to peer home-networking environment.

With respect to precision, for an interface description language to be precise, it should be possible to state the intention of the action and also distinguish between various actions. It would thus be advantageous to implement clearly stated rules for ambiguity occurrence and resolution. It would be further advantageous for the language to allow a single syntactic form for any semantic element. If the semantics for a particular element in a particular operating environment is different from that of its common notion, the interface description language should resolve such ambiguities by associating the particular semantics of the operating environment with a new and different syntactic element.

With respect to extensibility, it would be advantageous for the specification defined by the interface description language to be flexible enough to allow readers to skip portions that they may not completely understand which is especially important since the definition of the interface description language may follow a phased approach reaching new type systems over time. It would therefore be desirable to be able to extend the interface description language to express the semantics of any specific type system. Such an interface description language should also be rigid enough to lay out the overall structure and allow extensibility at the appropriate level, e.g., while deciding the constructs for protocol binding, it would be desirable to mandate only generic information and leave the protocol details to other specifications.

With respect to modularity, for ease of definition, it would be desirable to specify parts of the service or interface description independently and then include the separate parts, as needed or requested, e.g., standards forums could specify the interfaces a device should support and then a device manufacturer could import descriptions from possibly different sources to describe the collection of services supported by a device.

With respect to usage, it would be desirable to provide two ways to use a service or interface description. A first use is for clients to understand what the service offers and how to obtain it making it possible to obtain the service description from an already implemented or even already live service. A second use could be as the starting point during the implementation of a service. Thus, it would be desirable to be able to translate the service description to metadata in commonly used programming languages.

With respect to reuse, many simple and complex data types have already been well-represented in XML Schema (XSD) namespace. Simple Object Access Protocol (SOAP) encoding schema defines additional data representation for arrays and pointers. Thus, for an interface description language that accomplishes all of the above and more, it would be desirable to leverage existing schemas to the extent possible.

There is thus a need for a mechanism that provides a bridge, or structured framework, between an XML Schema and the object or type it structures, and vice versa. There is also a need for an interface description language that also determines the wire format for standard exchange of interface definitions among computing devices. There is still further a need for an interface description language that is capable of expressibility, abstraction, precision, extensibility, modularity, usage and reuse.

### SUMMARY OF THE INVENTION

In view of the foregoing, the present invention provides a Type Description Language (TDL), an extensible markup language (XML) based language, which provides an interface description that makes the mapping between an interface specification and its wire format deterministic and simple. The present invention provides seamless bridging between XML and object based views in a distributed environment. TDL leverages the duality between the type-based (objects) and XML-based views and may be used for exchanging metadata between various kinds of type (object) systems, such as Component Object Model (COM), Common Object Request Broker Architecture (CORBA), Common Language Runtime (CLR), etc. TDL proposes a new grammar for representing the behavioral aspect of a type and illustrates that there is a one to one mapping from an abstract type to a schema type and vice-versa.

Other features and embodiments of the present invention are described below.

### BRIEF DESCRIPTION OF THE DRAWINGS

The system and methods for providing an XML interface description language in a computing system are further described with reference to the accompanying drawings in which:

FIG. 1A is a block diagram representing an exemplary network environment having a variety of computing devices in which the present invention may be implemented;

FIG. 1B is a block diagram representing an exemplary non-limiting computing device in which the present invention may be implemented;

FIG. 2 is a block diagram illustrating that there may be a one to one mapping between a type system and a schema for describing the type system in accordance with the TDL of the present invention; and

FIGS. 3A through 3C illustrate exemplary communications that may take place in connection with a customer resource management service that makes use of TDL of the present invention.

### DETAILED DESCRIPTION OF PREFERRED EMBODIMENTS

Overview

In accordance with the present invention, a method and system are provided for making a device/object interface or service description that makes the mapping between an interface specification and its wire format deterministic, simple and obvious. As related in the background, it is desirable to be able to define a service or interface in a standard fashion. In connection with describing a service, one of ordinary skill in the art can appreciate that a service's action semantics include the behavior and the data types referred to by the behavior. To describe the behavior of a service, the present invention considers and supports the following notions. A service is a set of interfaces where each interface may itself be a collection of actions, properties and event sources. A service's properties may be accessed by clients to discover the state of the service. A service may be a container for multiple services. A service may inherit the behavior from another service and extend the behavior. Actions may be request-response or one-way interactions, and it should be possible to express exceptions raised by actions. A service may implement one or more actions. Device taxonomies may be represented as composite interfaces using multiple interfaces. Further, interface inheritance and the creation of new remote references to services are supported.

Additionally, in a distributed environment, a service presents itself to its clients in terms of the actions it can perform and the data it sends or receives in order to perform them, enabling clients in the environment to classify services and communicate with them. In accordance with the present invention, Type Description Language (TDL), an XML based language, is presented, which deterministically maps between an interface specification and its wire format.

Though specifying the service contracts is one aspect of the invention, integration with the European Computer Manufacturing Association (ECMA) type system is described in further embodiments below by extending the base definition of TDL to describe the behavioral and data aspects of any element of the ECMA type system. The present invention may be extended to any other type system as well. The below description is thus divided into two parts. The first part describes some general and detailed aspect of TDL in accordance with the present invention, such as exemplary language definitions of TDL that enable the description of services offered by devices and software applications alike. The second part described how the base definition of TDL, described in the first part, may be extended to another type system, such as the ECMA type system.

Notation

Some notational conventions are utilized in the present description with respect to namespaces that are now referred to for ease of description. Namespaces are not required to be resolvable URLs. When they do resolve, they return schema for their respective namespace. For purposes of the present description, they are illustrative, or exemplary, URLs and do not necessarily resolve to an actual location. XML namespaces provide a simple method for qualifying element and attribute names used in XML documents by associating them with namespaces identified by Universal Resource Identifier (URI) references. The attribute's value, a URI reference, is the namespace name identifying the namespace. The namespace name, to serve its intended purpose, has the characteristics of uniqueness and persistence. With this background, nonetheless, the “td1” and “ecma” URLs utilized herein are for illustrative purposes only, and may not resolve to an actual location.

The notational conventions referred to herein include xsi, soap-enc, xsd, tns and td1. “xsi” refers to http://www.w3c.org/2001/XMLSchema-instance and is the XML schema instance namespace. “soap-enc” refers to http://schemas.xm1soap.org/soap/encoding/ and is the soap encoding schema namespace. “xsd” refers to http://www.w3c.org/2001/XMLSchema and is the default namespace in schema fragment. “tns” refers to the current target namespace and “td1” refers to http://schemas.microsoft.com/td1 and is the default namespace for TDL elements. “ecma” refers to http://schemas.microsoft.com/ecma and is the ECMA schema namespace. “td1” and “ecma” are publicly available namespaces defined by TDL.

Exemplary Network Environments

One of ordinary skill in the art can appreciate that a computer or other client or server device can be deployed as part of a computer network, or in a distributed computing environment. In this regard, the present invention pertains to any computer system having any number of memory or storage units, and any number of applications and processes occurring across any number of storage units or volumes. The present invention may apply to an environment with server computers and client computers deployed in a network environment or distributed computing environment, having remote or local storage. The present invention may also applied to standalone computing devices, having programming language functionality, interpretation and execution capabilities for generating, receiving and transmitting information in connection with services.

Distributed computing facilitates sharing of computer resources and services by direct exchange between computing devices and systems. These resources and services include the exchange of information, cache storage, and disk storage for files. Distributed computing takes advantage of network connectivity, allowing clients to leverage their collective power to benefit the entire enterprise.

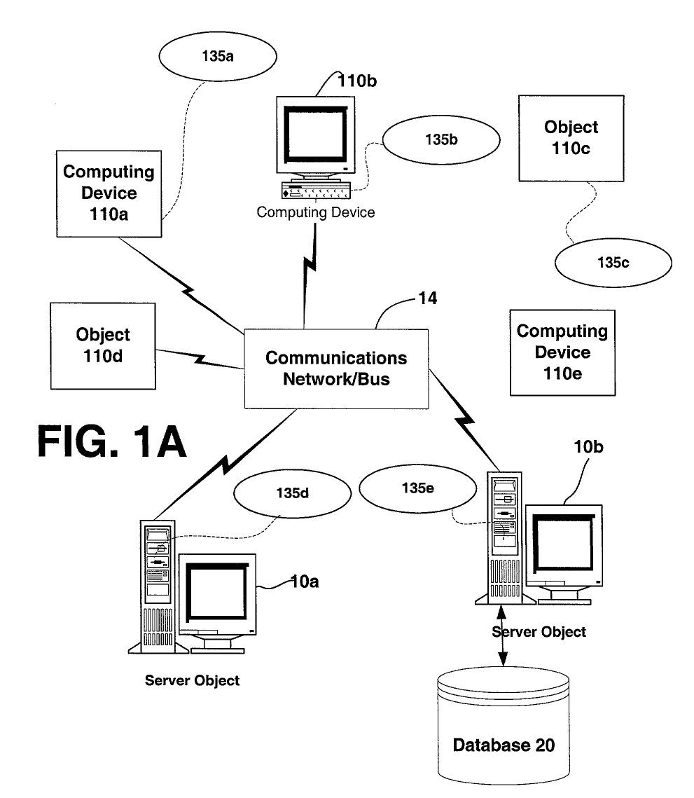

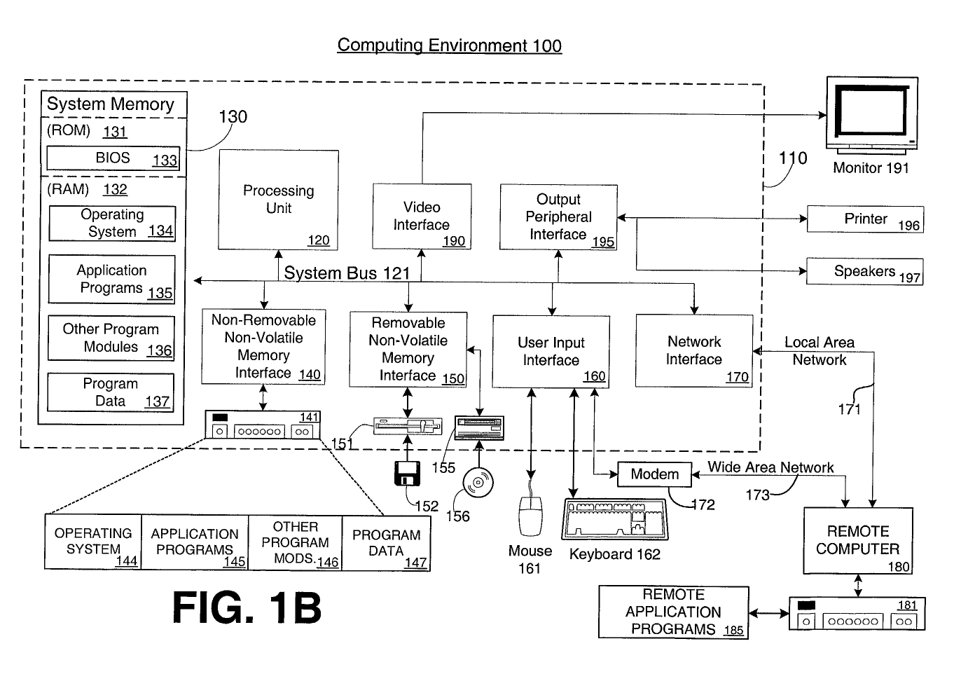

FIG. 1A provides a schematic diagram of an exemplary networked or distributed computing environment. The distributed computing environment comprises computing objects 10a, 10b, etc. and computing objects or devices 110a, 110b, 110c, etc. These objects may comprise programs, methods, data stores, programmable logic, etc. The objects comprise portions of the same or different devices such as PDAs, televisions, MP3 players, Televisions, personal computers, etc. Each object can communicate with another object by way of the communications network 14. This network may itself comprise other computing objects and computing devices that provide services to the system of FIG. 1A. In accordance with an aspect of the invention, each object 10 or 110 may contain services and data that would provide benefits to other of the objects 10 or 110. For example, where one of the objects may process MP3 data, another of the objects may provide an audio output of MP3 data or where one object may contain digital video data, another object may provide digital video output, and so on. In order to provide such benefits, objects 10 or 110 require capabilities that allow them to access the resources controlled or maintained by the other objects.

In a distributed computing architecture, computers that may have traditionally been used solely as clients communicate directly among themselves and can act as both clients and servers, assuming whatever role is most efficient for the network. This reduces the load on servers and allows all of the clients to access resources available on other clients thereby increasing the capability and efficiency of the entire network.

Distributed computing can help businesses deliver services and capabilities more efficiently across diverse geographic boundaries. Moreover, distributed computing can move data closer to the point where data is consumed acting as a network caching mechanism. Distributed computing also allows computing networks to dynamically work together using intelligent agents. Agents reside on peer computers and communicate various kinds of information back and forth. Agents may also initiate tasks on behalf of other peer systems. For instance, intelligent agents can be used to prioritize tasks on a network, change traffic flow, search for files locally or determine anomalous behavior such as a virus and stop it before it affects the network. All sorts of other services may be contemplated as well.

It can also be appreciated that an object, such as 110c, may be hosted on another computing device 10 or 110. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wireline or wireless systems, by local networks or widely distributed networks. Currently, many of the networks are coupled to the Internet, which provides the infrastructure for widely distributed computing and encompasses many different networks.

In home networking environments, there are at least four disparate network transport media that may each support a unique protocol such as Power line, data (both wireless and wired), voice (e.g., telephone) and entertainment media. Most home control devices such as light switches and appliances may use power line for connectivity. Data Services may enter the home as broadband (e.g., either DSL or Cable modem) and is accessible within the home using either wireless (e.g., HomeRF or 802.11b) or wired (e.g., Home PNA, Cat 5, even power line) connectivity. Voice traffic may enter the home either as wired (e.g., Cat 3) or wireless (e.g., cell phones) and may be distributed within the home using Cat 3 wiring. Entertainment Media may enter the home either through satellite or cable and is typically distributed in the home using coaxial cable. IEEE 1394 and DVI are also emerging as digital interconnects for clusters of media devices. All of these network environments and others that may emerge as protocol standards may be interconnected to form an intranet that may be connected to the outside world by way of the Internet.

The Internet commonly refers to the collection of networks and gateways that utilize the TCP/IP suite of protocols, which are well-known in the art of computer networking. TCP/IP is an acronym for “Transport Control Protocol/Interface Program.” The Internet can be described as a system of geographically distributed remote computer networks interconnected by computers executing networking protocols that allow users to interact and share information over the networks. Because of such wide-spread information sharing, remote networks such as the Internet have thus far generally evolved into an open system for which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process (i.e., roughly a set of instructions or tasks) that requests a service provided by another program. The client process utilizes the requested service without having to “know” any working details about the other program or the service itself. In a client/server architecture, particularly a networked system, a client is usually a computer that accesses shared network resources provided by another computer e.g., a server. In the example of FIG. 1A, computers 110a, 110b, etc. can be thought of as clients and computer 10a, 10b, etc. can be thought of as the server where server 10a, 10b, etc. maintains the data that is then replicated in the client computers 110a, 110b, etc.

A server is typically a remote computer system accessible over a remote network such as the Internet. The client process may be active in a first computer system, and the server process may be active in a second computer system, communicating with one another over a communications medium, thus providing distributed functionality and allowing multiple clients to take advantage of the information-gathering capabilities of the server.

Client and server communicate with one another utilizing the functionality provided by a protocol layer. For example, Hypertext-Transfer Protocol (HTTP) is a common protocol that is used in conjunction with the World Wide Web (WWW) or, simply, the “Web.” Typically, a computer network address such as a Universal Resource Locator (URL) or an Internet Protocol (IP) address is used to identify the server or client computers to each other. The network address can be referred to as a Universal Resource Locator address. For example, communication can be provided over a communications medium. In particular, the client and server may be coupled to one another via TCP/IP connections for high-capacity communication.

Thus, FIG. 1A illustrates an exemplary network environment, with a server in communication with client computers via a network/bus, in which the present invention may be employed. In more detail, a number of servers 10a, 10b, etc., are interconnected via a communications network/bus 14, which may be a LAN, WAN, intranet, the Internet, etc., with a number of client or remote computing devices 110a, 110b, 110c, 110d, 110e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to communicate to another computing device with respect to services.

In a network environment in which the communications network/bus 14 is the Internet, for example, the servers 10 can be Web servers with which the clients 110a, 110b, 110c, 110d, 110e, etc. communicate via any of a number of known protocols such as hypertext transfer protocol (HTTP). Servers 10 may also serve as clients 110, as may be characteristic of a distributed computing environment. Communications may be wired or wireless, where appropriate. Client devices 110 may or may not communicate via communications network/bus 14, and may have independent communications associated therewith. For example, in the case of a TV or VCR, there may or may not be a networked aspect to the control thereof. Each client computer 110 and server computer 10 may be equipped with various application program modules or objects 135 and with connections or access to various types of storage elements or objects, across which files may be stored or to which portion(s) of files may be downloaded or migrated. Any computer 10a, 10b, 110a, 110b, etc. may be responsible for the maintenance and updating of a database 20 or other storage element in accordance with the present invention, such as a database 20 for storing TDL interpretation software for interpreting TDL communications in accordance with the present invention. Thus, the present invention can be utilized in a computer network environment having client computers 110a, 110b, etc. that can access and interact with a computer network/bus 14 and server computers 10a, 10b, etc. that may interact with client computers 110a, 110b, etc. and other devices 111 and databases 20.

Exemplary Computing Device

FIG. 1B and the following discussion are intended to provide a brief general description of a suitable computing environment in which the invention may be implemented. It should be understood, however, that handheld, portable and other computing devices and computing objects of all kinds are contemplated for use in connection with the present invention. While a general purpose computer is described below, this is but one example, and the present invention requires only a thin client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can be implemented via an operating system, for use by a developer of services for a device or object, and/or included within application software that aids in the development of an interface according to TDL. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. The invention may also be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes.

FIG. 1B thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1B, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1B illustrates operating system 134, application programs 135, other program modules 136, and program data 137.

The computer 110 may also include other removable/non-removable, volatile/nonvolatile computer storage media. By way of example only, FIG. 1B illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1B provide storage of computer readable instructions, data structures, program modules and other data for the computer 110. In FIG. 1B, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1B. The logical connections depicted in FIG. 1B include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1B illustrates remote application programs 185 as residing on memory device 181. It will be appreciated that the network connections shown are exemplary and other means of establishing a communications link between the computers may be used.

.NET Framework

.Net is a computing framework that has been developed in light of the convergence of personal computing and the Internet. Individuals and business users alike are provided with a seamlessly interoperable and Web-enabled interface for applications and computing devices, making computing activities increasingly Web browser or network-oriented. In general, the .Net platform includes servers, building-block services, such as Web-based data storage and downloadable device software.

Generally speaking, the Net platform provides (1) the ability to make the entire range of computing devices work together and to have user information automatically updated and synchronized on all of them, (2) increased interactive capability for Web sites, enabled by greater use of XML rather than HTML, (3) online services that feature customized access and delivery of products and services to the user from a central starting point for the management of various applications, such as e-mail, for example, or software, such as Office .Net, (4) centralized data storage, which will increase efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform integration features as well. While exemplary embodiments herein are described in connection with software residing on a server and/or client computer, portions of the invention may also be implemented via an operating system or a “middle man” object between a network and device or object, such that services may be described in, supported in or accessed via all of Microsoft's .NET languages and services.

Type Description Language (TDL)

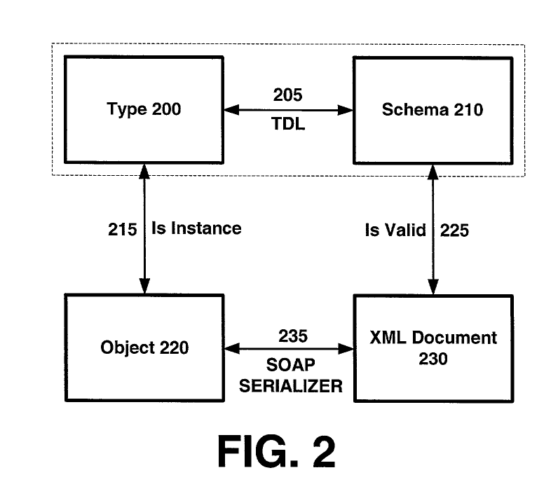

In view of the foregoing, the present invention provides a Type Description Language (TDL), an XML based language that provides an interface description that makes the mapping between an interface specification and its wire format deterministic, simple and obvious. The present invention provides seamless bridging between XML and object based views in a distributed environment. TDL leverages the duality between the type-based (objects) and XML-based views and may be used for exchanging metadata between various kinds of type (object) systems, such as COM, CORBA, CLR, etc. TDL proposes a new grammar for representing the behavioral and data aspects of a type and illustrates that there is a one to one mapping from an abstract type to a schema type and vice-versa. As illustrated by FIG. 2 and described in more detail below, TDL shows the duality between XML and Object based environments and advantages the CLR type system.

TDL takes the approach that all type systems have the same or similar constructs at the semantic level. Every type system has at least two aspects: a data aspect and a behavioral aspect, that is, when an endpoint X sends Message M to endpoint Y to carry out action A, the Message M contains the data useful for carrying out the desired Action A. The data aspect is used for describing Message M and the behavior aspect is used for describing Action A and its relationship with Message M. TDL utilizes XML Schemas (XSD), enhanced to represent typed references and arrays and with numerous syntactic restrictions such as usage of element representation for fields as the canonical syntax to represent the data aspect of a type. While some aspects of TDL are similar to SOAP, SOAP is far too loose a convention to enable a deterministic mapping between types and schema, and, inter alia, fails to handle common programming constructs such as pointers and arrays adequately. Thus, TDL proposes a new grammar for representing the behavioral aspect of a type as there is no existing standard XML syntax for completely and adequately expressing behavior constructs.

FIG. 2 captures the essence of the duality achieved by TDL between Object based and XML based views. FIG. 2 illustrates that there is a one to one mapping from an abstract type 200 to a Schema type 210 and vice-versa along pathway 205 in accordance with the present invention. There is also a one to one mapping from an instance 220 to an XML document 230 and vice-versa via a SOAP serializer 235 along pathway 235. The Is Instance operator along pathway 215 between an abstract type 200 and an instance 220 returns TRUE if and only if the Is Valid operator along pathway 225 returns TRUE between the corresponding XML Schema Type and XML Document. TDL is the first interface description language that ensures that both the Is Instance operator and Is Valid operator will return TRUE.

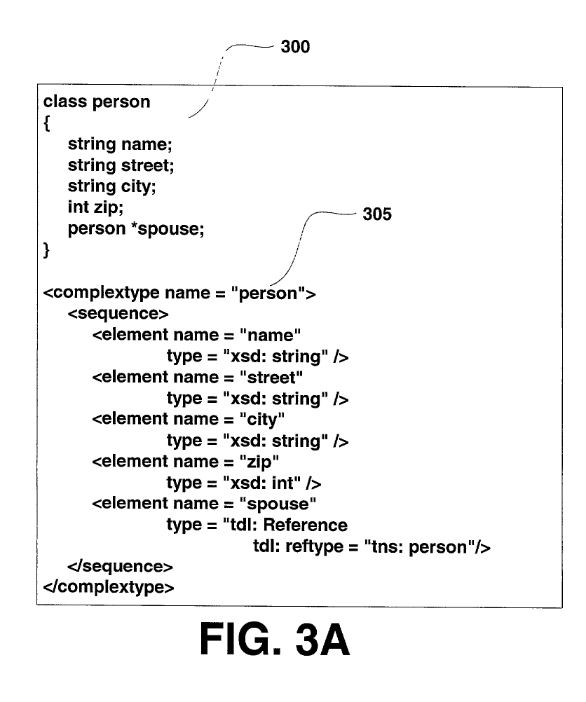

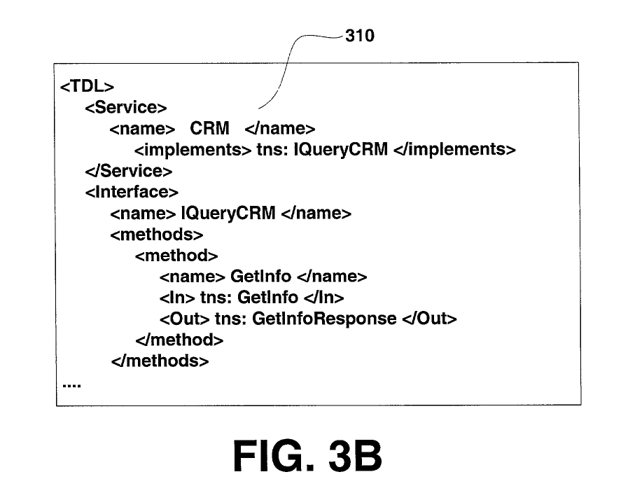

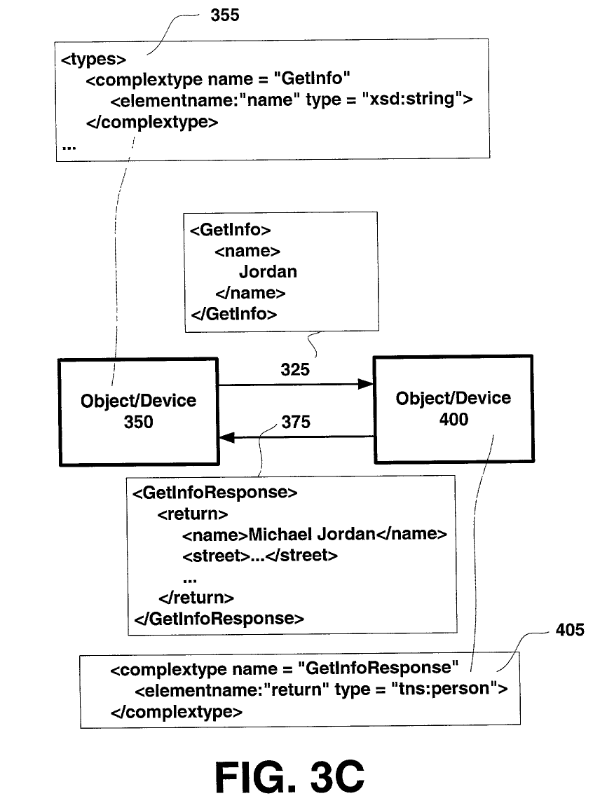

Prior to describing the details of the new grammar or syntax of TDL below, an exemplary illustration of its use is first presented in connection with FIGS. 3A to 3C. FIG. 3A illustrates a C++ programming class construct 300 for a person, wherein the class has strings name, street and city, an integer for zip code and a pointer to another person, the spouse of the person. Exemplary pseudocode 305 of FIG. 3A is the TDL that describes the class person, and in essence abstracts the class into a form that could be duplicated in any type system. Exemplary pseudocode 310 of FIG. 3B describes a service or interface for a device that may wish to make queries to another device or object relating to customer resource management (CRM) system for retrieving information relating to a name of a customer and other related information. Interface IQueryCRM has a method Getlnfo that may be used to retrieve information about people. Exemplary implementation of TDL syntax is described in more detail below.

Based upon the above described TDL class description 305 and service 310, if two devices or objects 350, 400 such as illustrated in FIG. 3C, have an understanding of the TDL class description 305 and corresponding service description 310, which TDL 305, 310 may be communicated at any time to devices 350, 400, then the schema 355 for generating a SOAP request by device 350 is as depicted according to TDL and similarly, the schema 405 for generating a SOAP response by device 400 is as depicted according to TDL. With the schemas 355 and 405 defined, a specific request may be made since the mapping is now deterministic according to TDL rules. Thus, the actual message passed, which in an exemplary embodiment is a SOAP request 325, through the communications network calls the method Getinfo searching for a customer named Jordan, and the actual message received in response is SOAP response 375, which returns the customer Michael Jordan and corresponding customer information, which may include street address, city, zip and spouse. Thus, beginning with a type system, and with the TDL transformation syntax or rules described below, a corresponding schema may be developed for describing object or device interfaces or services, and as a result, a common scheme for communicating service descriptions between different objects or devices in a network environment is provided.

Type Description Language (TDL) Base

As related in the background, present systems suffer various shortcomings. In this regard, the definition of TDL in accordance with the present invention has several advantageous features at least in the areas of expressibility, abstraction, precision, extensibility, modularity, usage, reuse and with respect to various synergistic combinations thereof.

With respect to expressibility, TDL includes sufficient information on all the parts of the action signature and supports subtyping. Further, TDL at least in part uses a generic notion of a type system in defining the language. In a distributed environment, TDL enables the specification for the protocol binding for a service's actions including specifying different kinds of binding e.g., SOAP, SMTP etc.

With respect to abstraction, TDL abstracts the first-class concepts of certain distributed environments as first-class primitives. Thus, while generic types may be a basis for TDL, there may also be elements that encapsulate primitive environment-specific concepts.

With respect to precision, TDL enables the ability to state the intention of the action and also distinguish between various actions because the rules for ambiguity occurrence and resolution in TDL are clearly stated as part of the language definition. TDL also allows a single syntactic form for any semantic element. If the semantics for a particular element in a particular environment is different from that of its common notion, TDL resolve such ambiguities by associating the environment semantics with a new and different syntactic element.

With respect to extensibility, the TDL specification is flexible enough to expect parts it may not completely understand, which enables a phased approach to the definition of TDL. TDL may be extended to express the semantics of any specific type system. Thus, TDL is designed to be rigid enough to lay out the overall structure and allow extensibility at the appropriate level. For example, while deciding the constructs for protocol binding, TDL may mandate generic information, while leaving the protocol details to other specifications.

With respect to modularity, for ease of definition, TDL enables the specification of parts of the service description independently and includes them, as needed. For example, with TDL, standard forums can specify the interfaces a device should support and a device manufacturer can import descriptions from possibly different sources to describe the collection of services supported by the device.

With respect to usage, a service description with TDL may be used for at least two primary purposes. A first primary use is for clients to understand what the service offers and how to obtain it. Thus, TDL makes it possible to obtain a service description from an already implemented or already live service. Secondly, a service description may be used as the starting point during the implementation of a service. Thus, TDL makes it possible to translate a service description to metadata in commonly used programming languages.

With respect to reuse, TDL makes use of existing schemas to the extent possible. For instance, many simple and complex data types have been well-represented in the XSD schema namespace already and are thus worth reusing. SOAP encoding schema further defines data representation for arrays, and thus TDL leverages these definitions as well.

Further to the above, when describing the behavior of a service, TDL supports the following notions: (1) A service is a set of interfaces where each interface can itself be a collection of actions, properties and event sources. (2) A service's properties can be accessed by clients to know the state of the service. (3) TDL enables the expression of exceptions raised by actions. (4) Actions can be request-response or one-way interactions. (5) A service can be a container for multiple services. (6) A service can inherit the behavior from another service and extend it. (7) A service can implement one or more actions. (8) Device taxonomies may be represented as composite interfaces using multiple interfaces in an environment supporting interface inheritance. (9) Creation of new remote references to services is supported.

TDL begins with the following basic outline for a service's behavior:

<service>*

<extends.../>?
<implements.../>?
<method.../>*
<property.../>*
<eventSource.../>*

</service>

and the following basic outline for an interface:

<interface>*

<extends.../>?
<method.../>*
<property.../>*

<eventSource.../>*

</interface>

It is also possible to represent child services as read-only properties with constant values, described in more detail below. For data types, TDL uses multiple schema namespaces and uses XSD types and soap-encoding types directly wherever possible. TDL defines a schema namespace to cover TDL specific data types. A TDL document instance limits its use of XSD schemas to a small feature set like simple and complex type definitions. TDL enables the creation of type definitions by simply filling in templates defined by TDL for various types, such as structs and classes.

In one embodiment, a layered approach is applied: Layer one is the minimum set of data types that are supported for the representation of a service's behavior. These constructs are direct mappings of commonly used types or types which represent special primitives specific to an environment. Layer one specifies enough document structure to serve as the basis for representing particular type systems, such as ECMA.

Layer two includes constructs that express the semantics of a particular type system. These constructs may be layered on top of layer one using annotations and global attributes. For example, TDL in the context of ECMA, for integration with the ECMA type system, is described in more detail below.

TDL accommodates complex types like classes that have both data as well as behavioral aspects. For example, a class may contain fields that are data members and methods that are part of the actions.

When including data types in layer one of the TDL description, for common primitive types such as int, float, and long (defined as part of ECMA), the data types are represented using XSD simple types. TDL also supports enumerations expressed as pairs of names and integer values. Bit fields represented as a collection of names corresponding to valid bit positions are also supported.

Classes are also supported, and in this regard, a distinction is made when the class is defined as a value type i.e., it cannot be referenced and can only be embedded, versus when it is a reference type and can be part of a graph like a cycle. Class members can themselves be of complex types. With TDL, it is also possible to specify the value associated with const class members. Arrays of simple and complex types are also supported. TDL also enables the specification of multi-dimensional arrays, jagged arrays, and sparse arrays. For certain peer to peer environments, event source may be added as a primitive type since event source is a core functionality for certain environments.

While defining certain data types, TDL also normalizes them by applying these core principles: (1) The difference between single-reference types and multi-reference types e.g., structs vs. classes, is maintained. (2) Multiple ways of representing fields, such as attributes vs. elements, are avoided. For example, in an exemplary implementation, element representation is used instead of attribute representation. This makes for standard implementation, and avoids the possibility of two different interfaces written by two different developers. (3) Global element name-type name distinctions are also avoided. In this regard, for every type, TDL defines and supports a single global element name in its schema namespace that has the same name as the type. (4) Additionally, the use of element substitution groups while representing fields of structs or classes is avoided. (5) Element substitution groups are used, however, to represent the elements of composite types without fields, e.g. collections, arrays. (6) Choice grouping constructs are also avoided. Subtyping is utilized to achieve functionality provided by “Choice” with a slight loss of strong typing at schema validation time.

The above normalization rules make the syntax for representing types via TDL simple, fixed, and obvious. Beyond the specification of actions and data types, TDL also has a mechanism for specifying constant values referred to by actions and data types.

While describing the generic types included in TDL herein, various programming examples are used for illustration purposes only. In particular, the various programming examples utilized herein do not imply that TDL derives the semantics of the type being described from the programming language of the examples. Instead, all data types supported by the base TDL definition are generic and commonly available across languages popular today.

The following description and examples provide exemplary illustration of the structure of a TDL Document. Given the design goals and the underlying rationale of TDL described above, the following structure for describing service behavior is provided by TDL:

<tdl:TDL targetNamespace=”uri”?>

<tdl:import namespace=”uri“ location=”uri“? /> *
<tdl:documentation>...</tdl:documentation> ?
<tdl:extension>...</tdl:extension> *
<tdl:actions> ?

<tdl:documentation.../> ?
<tdl:extension>...</tdl:extension> *
<tdl:service> *

<tdl:documentation.../> ?
<tdl:extension>...</tdl:extension>*
<tdl:name>...</tdl:name>
<tdl:extends>...</tdl:extends> ?
<tdl:implements> ?

<tdl:documentation.../> ?
<tdl:interface>...</tdl:interface> *

</tdl:implements>
<tdl:methods> ?

<tdl:methodparamOrder=”...”?> *

<tdl:documentation.../> ?
<tdl:extension>...</tdl:extension> *
<tdl:name>...</tdl:name>
<tdl:in>...</tdl:in> ?
<tdl:out>...</tdl:out> ?
<tdl:fault>...</tdl:fault> ?

</tdl:method>
<tdl:oneWayMethod> *

<tdl:documentation.../> ?
<tdl:extension>...</tdl:extension> *
<tdl:name>...</tdl:name>
<tdl:in>...</tdl:in> ?

</tdl:oneWayMethod>

</tdl:methods>
<tdl:properties> ?

<tdl:property>

<tdl:documentation.../> ?
<tdl:extension>...</tdl:extension> *
<tdl:name>...</tdl:name>
<tdl:type>...</tdl:type> ?
<tdl:accessor>...</tdl:accessor> ?

</tdl:property>

</tdl:properties>
<tdl:eventSources> ?

<tdl:eventSource> *

<tdl:documentation.../> ?
<tdl:extension>...</tdl:extension> *
<tdl:name>...</tdl:name>
<tdl:type>...</tdl:type> ?

</tdl:eventSource>

</tdl:eventSources>
<tdl:bindings> ?

<tdl:documentation.../> ?
<tdl:extension>...</tdl:extension> *
<tdl:binding>...</tdl:binding> *

</tdl:bindings>

</tdl:service>
<tdl:interface>*

<tdl:documentation.../> ?
<tdl:extension.../> *
<tdl:name>...</tdl:name>
<tdl:extends.../> ?

<tdl:documentation.../> ?
<tdl:interface>...</tdl:interface>*

</tdl:extends>
<tdl:methods.../> ?
<tdl:properties.../> ?
<tdl:eventSources.../> ?

</tdl:interface>

</tdl:actions>
<tdl:types> ?

<tdl:documentation.../> ?
<tdl:extension.../> *
<tdl:schema.../> *

</tdl:types>
<tdl:values> ?

<tdl:documentation.../> ?
<tdl:extension.../> *
<tdl:anyValueElement>...</tdl:anyValueElement> *

</tdl:values>
<tdl:bindings.../> ?
<tdl:TDL.../>*

</tdl:TDL>

For example, a service may be implemented using the following class:

namespace Devices.Sony {

struct ChannelRange {

int low;
int high;

}
class Channel {

string GetGuide ( );

}
class SonyDE545Tuner : ConnectableService, ITuner,
IAVProgramSource {

Channel currentChannel;
ChannelRange range;

}

}

With TDL in accordance with the present invention, this service be represented as:

<TDL targetNamespace=”http://www.sony.com/TDL/Devices.Sony/SonyAssembly”

xmlns:tns=”http://www.sony.com/TDL/Devices.Sony/SonyAssembly“
xmlns:ctns=”http://www.sony.com/TDL/Devices.Sony/SonyAssembly#Channel“
xmlns:sbns=”http://schemas.microsoft.com/ServiceBus/framework”
xmlns:tdl=”http://schemas.microsoft.com/tdl”
xmlns=”http://schemas.microsoftxom/tdl”>

<actions>

<service>

<name>Channel</name>
<methods>

<method>

<name>GetGuide</name>
<in>ctns:GetGuide</in>
<out>ctns:GetGuideResponse</out>

</method>

</methods>

</service>
<service>

<documentation>Describes a SonyDE545 tuner</documentation>
<name>SonyDE545Tuner</name>
<extends>sbns:ConnectableService</extends>

<implements>
<interface>sbns:ITuner</interface>

<interface>sbns:IAVProgramSource</interface>
</implements>

</service>

</actions>
<types>

<schema targetNamespace=

”http://www.sony.com/TDL/Devices.Sony/SonyAssembly#Channel”
xmlns:tns=
”http://www.sony.com/TDL/Devices.Sony/SonyAssembly#Channel”
xmlns:sbns=”http://schemas.microsoft.com/ServiceBus/framework”
xmlns:tdl=”http://schemas.microsoft.com/tdl”
xmlns=”http ://www.w3.org/.../XMLSchema”>

<complexType name=”GetGuide”>

<all/>

</complexType>
<complexTypename=”GetGuideResponse”>

<all>

<element name=”Result” type=”string”/>

</all>

</complexType>

</schema>
<schema

targetNamespace=”http://www.sony.com/TDL/Devices.Sony/SonyAssembly”

xmlns:tns=”http://www.sony.com/TDL/Devices.Sony/SonyAssembly”
xmlns:sbns=”http://schemas.microsoft.com/ServiceBus/framework”
xmlns:tdl=”http://schemas.microsoft.com/tdl”
xmlns=”http://www.w3.org/.../XMLSchema”>

<complexType name=”ChannelRange”>

<all>

<element name=”low” type=”int”/>
<element name=”high” type=”int”/>

</all>

</complexType>
<complexTypename=”SonyDE545Tuner”>

<all>

<element name=”currentChannel” type=”tdl:reference”

tdl:refType=”Channel” nillable=”true”/>

<element name=”range” type=”ChannelRange”/>

</all>

</complexType>

</schema>

</types>

</TDL>

For further example, if the ITuner interface had been independently standardized with the following definition:

public interface ITuner {

bool Power { get; set; }
bool Mute { get; set; }
bool Change (int id) {...}

}

the ITuner interface could be described as below with TDL:

<TDLtargetNamespace=”http://schemas.microsoft.com/.../ServiceBus/Framework”

xmlns:tns=”http://schemas.microsoft.com/.../ServiceBus/Framework”
xmlns:tdl=”http://schemas.microsoft.com/tdl”
xmlns=”http://schemas.microsoft.com/tdl” />

<interface>

<name>ITuner</name>
<methods>

<method>

<name>Change</name>
<in>tns:Change</in>
<out>tns:ChangeResponse</out>

</method>

</methods>
<properties>

<property>

<name>Power</name>
<type>xsd:boolean</type>
<accessor>all</accessor>

</property>
<property>

<name>Mute</name>
<type>xsd:boolean</type>
<accessor>all</accessor>

</property>

</properties>

</interface>
<types>

<schema

targetNamespace=”http://schemas.microsoft.com/.../ServiceBus/Framework#ITuner”

xmlns=”http://www.w3.org/.../XMLSchema” />

<complexType name=”Change”>

<all>

<element name=id” type=”int”/>

</all>

</complexType>
<complexTypename=”ChangeResponse”>

<all>

<element name=ChangeResult” type=”boolean”/>

</all>

</complexType>

</schema>

</types>

</TDL>

In accordance with the present invention, TDL elements include actions, services, interfaces, methods, properties and event sources. The actions element includes one or more service and interface definitions. The actions element is a wrapper element that aggregates all service and interface definitions into a single place.

A service element represents the actions of a concrete entity, which could be a software application or a device. The service element is a named collection of interfaces, methods, properties and event sources that the clients of the service can use. A service carries the implementation of all the interface contracts it declares. A service can inherit from another service, in which case it asserts the implementation of the contracts of the base service.

A service element further has name, extends, implements, methods, properties, eventSources and bindings elements. With respect to the name element, the service name must be chosen to be unique across all services defined in the TDL target namespace. The extends element indicates the base service whose implementation the service inherits. The implements element lists all the interfaces that the service implements. The methods element includes one or more methods that the service implements. The properties element includes one or more properties implemented by the service. The eventSources element describes one or more of the event sources the service supports. The bindings element section indicates the location of one or more services.

Like a service, an interface element is also a named collection of interfaces, methods, properties and event sources, but unlike a service, an interface element is an abstract entity and has no implementation backing it. The primary use of an interface is to ease the specification of contracts, which are then implemented as services.

An interface has name, extends, methods, properties and eventSources elements. The interface name must be chosen to be unique across all interfaces defined in the TDL target namespace. The extends element lists all the interfaces that the interface implies. The extends element can be used to described a composite interface. The methods element includes one or more methods that the service implements. The properties element includes one or more properties implemented by the service. The eventSources element describes one or more of the event sources the service supports.

The methods element includes one or more methods defined by a service or an interface. The methods element is a wrapper element that aggregates all method definitions into a single place. The methods element includes one or more of method and oneWayMethod elements. A method element describes a request response method. A oneWayMethod element describes a one-way method, which is a fire and forget method that expects no response.

The properties element includes one or more properties defined by a service or an interface. The properties element is a wrapper element that aggregates all property definitions in a single place.

The eventSources element includes one or more event sources defined by a service or an interface. The eventSources element is a wrapper element that aggregates all event sources definitions in a single place.

As one of ordinary skill in the programming arts can appreciate, a method is a named contract that can be invoked independently with a set of zero or more input parameters. A method can return zero or more result values and raise zero or more faults.

In accordance with the invention, a TDL method has name, in, out and fault elements. The method name must be chosen to be unique across all methods, properties and event sources encapsulated within the enclosing service or interface. The in element refers to the composite type containing all the input parameters of the method. The out element refers to the composite type containing all the output parameters of the method. The fault element refers to the composite type containing types of all the faults returned by the method.

In accordance with the invention, a method may have a paramOrder attribute. The paramOrder attribute is an optional attribute that can be used to indicate the order of the parameters.

The composite types referenced in the method declaration can be resolved by defining them in the types section as illustrated below:

<complexType name=”method”>

<all>

<element name=”in/inout parameter name” type=
”parameter type”/>
...

</all>

</complexType>
<complexType name=”methodResponse”>

<all>

<element name=”out/inout parameter name”

type=”parameter type”/>

...

</all>

</complexType>
<complexType name=”methodFault”>

<all>

<element name=”exception field” type=”exception
field type”/>
...

</all>

</complexType>

Since these composite types are implicitly created by TDL, they are defined in a separate schema namespace to avoid collisions. The name of the schema namespace is created using the current target namespace followed by the interface or service name as the URL fragment:

“<current target namespace>#<service or interface name>”

For example, given a method:

string GetString (int);

defined inside a service “MyService” in the target namespace:

<TDL targetnamespace=“http://www.mydomain.com/NSAssem/xx.yy/MyAssembly”>

the parameter types GetString and GetStringResponse would be defined in

<schema targetnamespace=“http://www.mydomain.com/NSAssem/xx.yy/MyAssembly#MyService”>

Since separate composite types are defined to represent the in and out parameters of a method respectively, it might not be possible to restore the original order by looking at the elements of these composite types.

Thus, to indicate the parameter order, a global attribute paramOrder is defined in the td1 namespace that can contain a string that indicates the parameter names in the correct order, as per the following:

<attribute name=“paramOrder” type=“xsd:string” form=“qualified”/>

For instance, given the above definitions, a method func (a1 in, a2 inout, a3 in, a4 out) translates to the following using TDL:

<method td1:paramOrder=“a1,a2,a3,a4”. . . />

A one-way method is a named contract that can be invoked independently with a set of zero or more input parameters. A one-way method does not return any value, but rather follows a pattern of fire or call and then forget.

With TDL, a oneWayMethod has name and in elements. The method name must be chosen to be unique across all methods, properties and event sources encapsulated within the enclosing service or interface. The in element refers to the composite type containing all the input parameters of the method. As with the case of a non-oneWayMethod, the composite type referenced in the one-way method declaration can be resolved by defining it in the types section.

As one of ordinary skill in the programming arts can appreciate, a property defines a named value and the methods to access the value. The named value is of a particular type and the property may support get, set or all methods.

A TDL property has name, type and accessor elements. The property name must be chosen to be unique across all the methods, properties and event sources encapsulated within the enclosing service or interface. The property type is a qualified name referring to a type definition present in a schema namespace. The TDL type section can be used to define the property type. The accessor attribute defines the mode of operations allowed on the property. Valid values are get, set or all.

An event source defines a typed entity that supports subscription. When the event occurs, a value of the type is returned to the subscriber. Commonly assigned U.S. Pat. Appln. No. XX/YYY,ZZZ, filed on Month Day, Year, entitled “Title of the ServiceBus Eventing Model Patent Application” disclosing additional details concerning eventing and eventing models.

A TDL EventSource has name and type elements. The event source name must be chosen to be unique across all the methods, properties, and event sources encapsulated within the enclosing service or interface. The event type is a qualified name referring to a type definition present in a schema namespace. The TDL types section can be used to define the event type.

The bindings section can be used to specify the location of one or more services. The bindings section may include one or more binding elements. Bindings can be specified as part of a service definition or outside of the service definition. When specified as part of the service definition, bindings can only be applied to the enclosing service. Outside the service definition, bindings can be specified for any service.

TDL defines a global element called binding in the td1 schema namespace. Custom binding elements can be specified using substitution groups with binding as the head element. The base binding element has an optional serviceType attribute of type qname that can be used to specify TDL service definition to which the binding applies. The serviceType attribute is used when the binding is specified outside the service definition. Exemplary TDL pseudocode for the binding element is as follows:

<element name=”binding” type=”tns:binding”/>
<complexType name=”binding”>

<attribute name=”serviceType” type=”xsd:qname”/>

</complexType>

For example, SOAP binding may be specified as follows:

<element name=”soapBinding” type=”soapBinding”

substitutionGroup=”tdl:binding”/>

<complexType name=”soapBinding>

<complexContent>

<extension base=”tdl:binding”>

<all>

<element name=”url” type=”uri”/>

</all>

</extension>

</complexContent>

</complexType>

and an exemplary SOAP binding might appear as follows:

<soapBinding>

<url>http://www.foobar.com/StockQuoteService</url>

</soapBinding>

The types element includes one or more XSD schemas. The types element provides a convenient place to define all the data types referred to by the other TDL elements.

In one embodiment, TDL bases its data types on XSD and SOAP-ENC XML schema namespaces. TDL extends, restricts or annotates them to define the TDL schema namespace. This includes generic type elements, primitive types defined by particular peer to peer environments, such as a peer to peer network for the home or business enterprise, as well as annotations and global attributes required for representing the metadata of generic types and TDL elements. TDL types are described in more detail below. Every element that is defined must be chosen to have a unique name in the context of its target schema namespace.

The extensions section allows one or more extension elements to appear within it. An extension element is allowed at almost any of the points in TDL. Further, TDL supports attribute extensions on all the elements defined by TDL. TDL defines a global element called extension in the td1 schema namespace for the extension element. Custom extension elements can be specified using substitution groups with extension as the head element.

The values section allows one or more instance values to appear within it. The values section enables the specification of constant values of complex types in the other TDL sections, illustrated below in more detail. TDL defines a global element in the td1 schema namespace called anyValueElement. Custom value elements are specified using substitution groups with this global element as the head element.

The import element enables the use of definitions from other TDL or XSD namespaces in the current TDL target namespace. The Documentation element is allowed inside by all TDL elements. The Documentation element may include any text or XML elements intended to improve the readability of the TDL document.

TDL Data Types include simple types and constructed types. With respect to simple types, the TDL Base definition directly uses the primitive types contained in the XSD schema namespace for the primitive types defined as part of ECMA submission. Layered Extensions can be built on top of these primitive types by restricting their value sets if necessary. With respect to constructed types, a TDL enumeration type e.g., enum type, is a value type based on one of the integer primitive types. A TDL enumeration type consists of a set of named elements. Values of an enumeration type typically consist of a consecutive range of integers starting at zero. It is also possible to specify the integer value associated with a specific element name, in which case the values of successors to that element are successors of that integer value.

Exemplary use of XSD enumeration to represent the TDL enumeration type in terms of the element names is illustrated as follows:

<simpleType name=“user-defined enum type name“ tdl:enumType=”qname”>

<restriction base=“string“>

<enumeration value=“user-defined name“ tdl:enumValue=”user-defined value”? />
...

</restriction>

</simpleType>

In the example, td1:enumType is an annotation on the type and gives the base integer type associated with the type. td1:enumType is defined as a global attribute in the following td1 schema namespace:

<attribute name=enumType type=”string”

form=”qualified” default=”xsd:int”/>

In the example, td1:enumValue is another global attribute that allows the explicit setting of the integer value corresponding to the following element name:

<attribute name=enumValue type=”int” form=”qualified”/>

For example, given exemplary pseudocode enum Color={red=1, green, blue}, the type may appear as follows:

<simpleType name=“Color“>

<restriction base=“xsd:string“>

<enumeration value=“red“ tdl:enumValue=”1”/>
<enumeration value=“green“/>
<enumeration value=“blue“/>

</restriction>

</simpleType>

In an exemplary embodiment, when an enumValue is not explicitly specified, the value is implicitly one greater than the predecessor or 0 if it is the first enumeration.

A bit field is a mathematical powerset on the values of its base type. The base type itself is a collection of named elements, where each element has an associated value of an integer type. A value of a bit field type includes a combination of one or more elements of the base type. TDL represents a bit field as follows:

<simpleType name=“user-defined type name“ tdl:enumType=”qname”>

<list>

<simpleType>

<restriction base=“string“>

<enumeration value=“user-defined name“

tdl:enumValue=”user-defined value”? />

...

</restriction>

</simpleType>

</list>

</simpleType>

For instance, given a bit field specified as follows:

[Flags]

Color={red=1, green=2, blue=8},

the TDL type may appear as follows:

<simpleType name=Color>

<list>

<simpleType>

<restriction base=“xsd:string“>

<enumeration value=“red“ tdl:enumValue=”1”/>
<enumeration value=“green“ tdl:enumValue=”2”/>
<enumeration value=“blue“ tdl:enumValue=”8”/>

</restriction>

</simpleType>

</list>

</simpleType>

If an element cc of type Color had the value redigreen, the data may appear as a space separated list of values, as follows:

<cc>red green</cc>

A TDL struct is a single-reference composite type that is a collection of named fields that are themselves of any simple or composite type supported by TDL. The fields of a struct may be accessed using their names. In one embodiment, reference to a struct cannot be null. The XSD complexType may directly represent a TDL struct, as follows:

<complexType name=”struct name” tdl:struct=”true”>

<all>

<element name=”field name” type=”field type”/>
...

</all>

</complexType>

In this example, td1:struct is a global attribute defined in the following td1 namespace:

<attribute name=”struct” type=”xsd:boolean” form=”qualified”/>

Since a struct is a value type, the schema fragment does not have the id attribute.

For every struct, TDL defines and supports a single global element in the struct namespace. This global element has the same name as the struct name, for example:

<element name=”struct name” type=”struct name”

substitutionGroup=”tdl:anyValueElement”/>

where anyValueElement is defined as a global element in the following td1 namespace:

<element name=”anyValueElement” type=”xsd:anyType”

abstract=”true”/>

The substitution group is useful, for instance, when the struct appears as the element type of an array.

A TDL class is a multi-reference composite type that is a collection of named fields that are themselves of any simple or composite type supported by TDL. The fields of a class can be accessed using their names. A class can specify type inheritance, in which case it inherits all the fields specified in the base class.

Unlike a struct, a TDL class is normally a multi-reference type. TDL defines the following attribute group in the td1 namespace to achieve value referencing:

<attributeGroupname=”classRefAttrs”>

<attribute name=”id” type=”ID” minOccurs=”0”/>
<attribute name=”href” type=”string” minOccurs=”0”/>

</attributeGroup>

A class which is not a subtype can be represented by the following:

<complexType name=”class name”>

<all>

<element name=”field name” type=”field type”/>
...

</all>
<attributeGroup ref=”tdl:classRefAttrs”/>

</complexType>

A class which derives from another class is represented by the following:

<complexType name=”class name”>

<complexContent>

<extension base=”base class name”>

<all>

<element name=”field name” type=”field type”/>
...

</all>

</extension>

</complexContent>

</complexType>

If the multi-reference property of a class is overridden and it is specified as a single-reference type, two cases arise:

a) When the class is not a subtype, the class may be represented by the following schema fragment:

<complexType name=”class name”>

<all>

<element name=”field name” type=”field type”/> *

</all>

</complexType>

The difference between this class and a struct is that by definition a reference to the class can be null while a reference to a struct can never be null.

b) When the class derives from a base type, the class may be represented by the following schema fragment:

<complexType name=”class name”>

<complexContent>

<extension base=”base class name”>

<all>

<element name=”field name” type=”field type”/>
...

</all>

</extension>

</complexContent>

</complexType>

For every class, TDL defines and supports a single global element in the class namespace. This global element has the same name as the class name, as follows:

<element name=”class name” type=”class name”

substitutionGroup=”tdl:anyValueElement”/>

In this example, td1:anyValueElement is as defined earlier. The substitution group is useful when the class appears as the element type of an array.

With respect to fields in TDL, a struct or a class field is completely defined by the field name and its type. Fields can be represented as elements of the XSD complex type representing the enclosing composite type.

If a field has a unique, or single, reference to an instance of a type that cannot be null, e.g. struct, the field is represented by the following:

<element name=”field name” type=”fieldType”/>

If a field has a unique, or single, reference to an instance of a type that can be null, e.g. class, the field is represented by the following:

<element name=”field name” type=”fieldType” nillable=”true”/>

If a field has a shared, or multiple, reference to an instance of a type, e.g. class, the field is represented by the following:

<element name=”field name” type=”tdl:reference”
tdl:refType=”fieldType”

nillable=”true”/>

where td1:reference itself is defined as a complex XSD type in the td1 namespace as:

<complexType name=”reference” final=”#all”>

<attribute name=”href” type=”string” minOccurs=”1”>

</complexType>

and td1:refType is a global attribute in the td1 namespace, as follows:

<attribute name=”refType” type=”string” form=”qualified”/>

Since type inheritance affects the data corresponding to the field at runtime, the xsi:type attribute is specified with the instance data whenever the type of a field is a subtype. For instance, the following is an example involving structs, classes and their fields:

struct WeekTime {

int weekDay;
int hour;
int minute;

};
class Employee {

string name;
int empId;

};
class Manager : Employee {

int mgrId;

};
class Presentation {

Employee speaker;
WeekTime startTime;

};

With TDL, the above types are represented by

<complexType name=”WeekTime” tdl:struct=”true”>

<all>

<element name=”weekDay” type=”int”/>
<element name=”hour” type=”int”/>
<element name=”minute” type=”int”/>

</all>

</complexType>
<complexType name=”Employee”>

<all>

<element name=”name” type=”string”/>
<element name=”empId” type=”int”/>

</all>
<attributeGroupref=”tdl:classRefAttrs”/>

</complexType>
<complexType name=”Manager”>

<complexContent>

<extension base=”Employee”>

<all>

<element name=”mgrId” type=”int”/>

</all>

</extension>

</complexContent>

</complexType>
<complexType name=”Presentation”>

<all>

<element name=”speaker”

type=”tdl:reference”
tdl:refType=”tns:Employee”
nillable=”true”/>

<element name=”startTime” type=”WeekTime”/>

</all>
<attributeGroupref=”tdl:classRefAttrs”/>

</complexType>

With respect to the above example, data for two employees XX and YY, where XX is a regular employee and YY is a manager may be as follows:

<Employee id=”XX-ID”>

<name>XX</name>
<empId>1</empId>

</Employee>
<Manager id=”YY-ID”>

<name>YY</name>
<empId>1</empId>
<mgrId>1</mgrId>

</Manager>

If XX is the speaker on Wednesday at 10.00 a.m., the presentation data may appear as follows:

<Presentation>

<speaker href=”#XX-ID”/>
<startTime>

<weekDay>2</weekDay>
<hour>10</hour>
<minute>2</minute>

</startTime>

</Presentation>

Since speaker is a shared, or multi, reference field, TDL has a reference to speaker data whereas the startTime data appears inline. If YY is the speaker, the speaker would appear with the instance type as follows:

<Presentation>

<speaker href=”#YY-ID”/>
<startTime>

<weekDay>2</weekDay>
<hour>10</hour>
<minute>2</minute>

</startTime>

</Presentation>

On the other hand, if speaker has been declared as a single reference field which is nullable in Presentation,

class Presentation{

[SOAP (Embedded=true)]
Employee speaker;
WeekTime startTime;

};

the schema fragment defining Presentation would be as below:

<complexType name=”Presentation”>

<all>

<element name=”speaker” type=”tns:Employee”
nillable=”true”/>
<element name=”startTime” type=”tns:WeekTime”/>

</all>

</complexType>

If XX is the speaker on Wednesday at 10.00 a.m., the Presentation data would appear as below:

<Presentation>

<speaker>

<name>XX</name>
<empId>1</empId>

</speaker>
<startTime>

<weekDay>2</weekDay>
<hour>10</hour>
<minute>2</minute>

</startTime>

</Presentation>

Since Presentation has only shared references in both speaker and startTime fields, the data for both the fields appears inline.

If YY is the speaker, the speaker data would appear with the instance type as

<Presentation>

<speaker xsi:type=”tns:Manager”>

<name>YY</name>
<empId>1</empId>
<mgrId>1</mgrId>

</speaker>
<startTime>

<weekDay>2</weekDay>
<hour>10</hour>
<minute>2</minute>

</startTime>

</Presentation>

As one of ordinary skill in the art can appreciate, an array type is described by its element type and the number of dimensions of the array. Since TDL supports arrays of arrays, i.e. jagged arrays, TDL uses the id and href mechanism to access the inner arrays.

TDL uses the array representation from the soap-encoding schema namespace to represent TDL arrays; however, TDL restricts the multiple choices for the element names provided by SOAP, by utilizing the anyValueElement substitution group for array elements. The array element name indicates the type name, even with arrays that have composite type elements that are in turn subtyped.

TDL defines an Array complex type in the td1 namespace as follows:

<complexType name=”Array”>

<complexContent>

<extensionbase=”soap-enc:Array”/>

<sequence>

<element ref=”tdl:GlobalTypeElement”

maxOccurs=”unbounded”/>

</sequence>
<attributeGroup ref=”tdl:classRefAttrs”/>
<attributeGroup ref=”soap-enc:arrayAttrs”/>

</extension>

</complexContent>

</complexType>

TDL also defines and supports a global element in the td1 namespace that has the name Array:

<element name=“Array” type=“td1:Array”

substitutionGroup=“td1:anyValueElement”/>

With this example, td1:anyValueElement is as defined above. The substitution group is useful when an array appears as the element type of an array. TDL also defines td1:arrayType as a global attribute in the td1 namespace that can be used to annotate the type information with the actual array type, i.e.:

<attribute name^{:}=”arrayType” type=”string” form=”qualified”/>

The use of arrays with TDL is illustrated using several examples below.

Given the above presented definition of WeekTime, if there is a class field which is of an array type such as the following:

WeekTime[3] today;

its representation with TDL is as follows:

<element name=”today” type=”tdl:Array” tdl:arrayType=”WeekTime[]”/>

The actual array type information would appear as an attribute in the instance data as follows:

<today soap-enc:arrayType=”WeekTime[3]”>

<tns:WeekTime>

<weekday>3</weekday>
<hour>10</hour>
<minute>0</minute>

</tns:WeekTime>
<tns:WeekTime>

<weekday>3</weekday>
<hour>12</hour>
<minute>30</minute>

</tns:WeekTime>
<tns:WeekTime>

<weekday>3</weekday>
<hour>15</hour>
<minute>0</minute>

</tns:WeekTime>

</today>

Similarly, given the above definitions of Employee and Manager, if there is a field which is an array of Employees, such as the following:

Employee[ ] devteam;

its representation in TDL is as follows:

<element name=”devteam” type=”tdl:Array”
tdl:arrayType=”Employee[ ]”/>

The elements of the array can be Employee or any of its subtypes. Since Employee is a shared reference type, the instance data would appear as follows:

<devteam soap-enc:arrayType=”Employee[2]”>

<tns:Manager href=”#YY-ID” />
<tns:Employee href=”#XX-ID”/>

</devteam>

Note the use of element name to represent elements of the array.

If, instead, Employee and Manager were defined as single-reference types, the instance data would appear as follows:

<devteam soap-enc:arrayType=”Employee[2]”>

<Employee>

<name>XX</name>
<empId>1</empId>

</Employee>
<Manager>

<name>YY</name>
<empId>1</empId>
<mgrId>1</mgrId>

</Manager>

</devteam>

If instead, for example, there is a field that is an array of arrays, such as the following:

Employee [ ][ ] subteams;

its representation in TDL is as follows:

<element name=”subteams” type=”tdl:Array”
tdl:arrayType=”Employee[ ][ ]”/>

The array type information appears as an attribute in the instance data and the element names directly indicate data elements that are of a subtype as follows:

<subteamssoap-enc:arrayType=”Employee[ ][2]”>

<tdl:array href=”#subteams-1-ID”/>
<tdl:array href=”#subteams-2-ID”/>

</subteams>
<tdl:array id=”subteams-1-ID” soap-enc:arrayType=”Employee[3]”>

<tns:Manager href=”#YY-ID”/>
<tns:Employee href=”#XX-ID”/>
<tns:Employee href=”#ZZ-ID”/>

</tdl:array>
<tdl:array id=”subteams-2-ID” soap-enc:arrayType=”Employee[2]”>

<tns:Manager href=”#RR-ID”/>
<tns:Employee href=”#SS-ID”/>

</tdl:array>

With respect to constant values in TDL, a constant value of a simple type may be represented using the XSD fixed constraint. For example, the following pseudocode:

class AA {

const Int c1 = 5.0;

}

may be represented in TDL by the following:

<complexType name=”AA”>

<all>

<element name=”c1” type=”int” fixed=”5” maxOccurs=”0”/>

</all>

</complexType>

To represent constant values of complex types, TDL defines a global attribute constantValue in the td1 namespace:

<attribute name=”constantValue” type=”xsd:string” form=”qualified”/>

For example, for the following exemplary pseudocode:

class BB {

int c1;
int c2;

}
and
class CC {

const BB bb = new BB (5, 6);
int c3;

}

the types schema namespace includes the following definitions:

<complexType name=“BB“>

<all .../>

</complexType>
<element name=”BB” type=”tns:BB”

substitutionGroup=”tdl:anyValueElement”/>

<complexType name=“CC“>

<all>

<element name=”bb” type=”tns:BB” maxOccurs=”0”

tdl:constantValue=”#Valuebb” />

<element name=”c3” type=”xsd:int”/>

</all>

</complexType>
<element name=”CC” type=”tns:CC”

substitutionGroup=”tdl:anyValueElement”/>

and the TDL values section includes the value of bb:

<values>

<AA id=”Valuebb”>

<c1>5</c1>
<c2>6</c2>

</AA>

</values>

It is of note that the td1:constantValue may also represent simple or primitive types directly using the distinction that they do not start with # character, thereby avoiding the indirection. In one embodiment, the # character can be escaped when representing string values.

It was mentioned above that properties can be used to obtain the child services of a composite service. To achieve this, TDL uses the td1:constantValue global attribute to directly obtain the location of the child service instead of accessing the property value at execution time. For example, given the following exemplary pseudocode:

class AVService {

Tuner tuner1;
Tuner tuner2;
...

};

the child services may be accessed directly using the constantValue attribute in the properties specified in the A VService definition as follows:

<property >
<name>tuner1</name>
<type tdl:constantValue=”tuner1”>tns:Tuner</type>
<accessor>get</accessor>

</property>

<property >
<name>tuner2</name>
<typetdl:constantValue=”tuner2”>tns:Tuner</type>
<accessor>get</accessor>

</property>

If the AVService is located at “http://www.mydomain.com/AvService,” the first tuner can be accessed using “http://www.mydomain.com/AvService/tuner1.”

With TDL, a service may also represent its child services in an array. For example, given the following exemplary pseudocode:

class AVService {

Tuner tuners[2];
...

};

then the array of child services may be accessed using the #ValueOfTuners reference specified in the property definition as follows:

<property>
<name>tuners</name>
<type tdl:constantValue=”#ValueOfTuners”>tdl:array</type>
<accessor>get</accessor>

</property>

Individual services may be accessed using the relative URLs contained in the values section:

<values>

<tdl:array id=”ValueOfTuners” soap-enc:arrayType=”string[2]”>

<string>tuner1<string>
<string>tuner2<string>

</tdl:array>

</values>

If the AVService is located at “http://www.mydomain.com/AvService”, the first tuner can be accessed using “http://www.mydomain.com/AvService/tuner1.”

Transferring a service reference across an application boundary requires information about the service, such as a URI, that uniquely identifies the specific service instance being transferred.

TDL defines a serviceReference type in the TDL type section as follows:

<complexTypename=”serviceReference”>

<all>

<element name=”URL” type=”xsd:uri”/>

</all>

</complexType>

<element name=”serviceReference” type=”tns:serviceReference”

substitutionGroup=”tdl:anyValueElement”/>

A field that can transmit a service reference across an application boundary may be represented as follows:

<element name=”service name” type=”tdl:serviceReference”
tdl:reftype=”service type”/>

With this example, the reftype annotation specifies the static type of the field. The reference being transferred is an instance of the static type of the field. For example, if tuner is transmitted by reference in connection with the following type:

class Receiver {

Tuner tuner;

};

its representation in TDL may be as follows:

<complexType name=”Receiver”>

<all>

<element name=”tuner” type=”tdl:serviceReference”
reftype=”tns:Tuner”>

</all>

</complexType>

Since a service supports dynamic query of its type by its clients, services also support the following inspection methods:

boo1 IsInstanceOf (qname type)

Xm1Element GetServiceDescription ( )

Consequently, TDL services are presumed to extend the following base service:

<service>

<name>TDLBaseService</name>
<method>

<name>IsInstanceOf</name>
...

</method>
<method>

<name>GetServiceDescription</name>
...

</method>

</service>

Type Description Language (TDL) ECMA and other Type Systems

As described above in detail, TDL enables the specification of interfaces a service offers and makes the mapping between the interface specification and its wire format deterministic, simple and obvious. The present description illustrates how each element of other type systems may map to TDL.

In one embodiment, how each element in the ECMA type system maps to TDL is described. In cases where a direct mapping is not sufficient, the TDL type may be extended with XSD annotations and global attributes. TDL and the layer built on top of TDL together may be used to describe all ECMA type elements. Since TDL is flexible enough to define new elements that can appear in the extension section of TDL, we can use the same approach to describe the behavioral and data aspects of the elements of any type system.

One of ordinary skill in the art can appreciate that the below-described example of extending TDL to an ECMA type system illustrates more generally that any type system may extend TDL to express the elements of the particular type system.

To extend TDL to express ECMA type elements, a schema namespace is defined to cover ECMA specific data types. While defining the data types, the same principles of normalization as outlined in the TDL Base description above are applied. Special attention is paid to ECMA types that have both data as well as behavioral aspects. For example, an ECMA class includes fields that are data members and methods that are part of the actions.

To achieve the extension of TDL to an ECMA type system, a walkthrough is presented for each ECMA type, to examine its data and behavioral aspects and to define XSD annotations or global attributes if required. If extension elements need to be added to the TDL document structure, the TDL extension substitution group may be used for these purposes.

Some special aspects of ECMA include overloading of methods and operators, expressing all ECMA access modifiers, ECMA attributes, nested types, commonly used classes like GUID, DateTime and TimeSpan, ECMA Types and ECMA Primitive Types

The TDL Base definition directly uses the primitive types contained in the XSD schema namespace for the primitive types defined as part of ECMA submission. TDL extended for ECMA defines a mapping for each ECMA primitive type to an existing XSD type or introduces new types in the ecma schema namespace.

The types listed in Table I below have no behavioral aspect.

TABLE I

| | Base | |
|---|---|---|
| | Schema | |
| ECMA Type | Type | Description |
| Byte | xsd:unsigned- | An unsigned |
| | byte | 8-bit integer |
| Boolean | xsd:Boolean | A Boolean value |
| Char | xsd:character | A single Unicode |
| | | character |
| Decimal | xsd:decimal | Derives from |
| | | xsd:decimal with |
| | | range restrictions |
| Double | xsd:double | A double-precision |
| | | floating-point number |
| Int16 | xsd:short | A signed 16-bit |
| | | integer |
| Int32 | xsd:int | A signed 32-bit |
| | | integer |
| Int64 | xsd:long | A signed 64-bit |
| | | integer |
| IntPtr | xsd:long | ECMA defines it to |
| | | be of native size. We |
| | | choose to map to the |
| | | TDL type with the |
| | | maximum length. |
| Sbyte | xsd:byte | A signed 8-bit |
| | | integer |
| Single | xsd:float | A single-precision |
| | | floating-point number |
| String | xsd:string | A character string |
| UInt16 | xsd:unsigned- | an unsigned 16-bit |
| | short | integer |
| UInt32 | xsd:unsigned- | an unsigned 32-bit |
| | int | integer |
| UInt64 | xsd:unsigned- | an unsigned 64-bit |
| | long | integer |
| UIntPtr | xsd:unsigned- | ECMA defines it to |
| | long | be of native size. We |
| | | choose to map to the |
| | | TDL type with the |
| | | maximum length. |
| XmlElement | xsd:any | |
| XmlAttribute | xsd:anyAttribute | |

The ECMA decimal type has more restrictions than xsd:decimal, and thus TDL extended for ECMA is represented with a different type name as follows:

<simpleType name=“ecmaDecimal“>

<restriction base=“decimal“>

<totalDigits value=“29“ fixed=“false“/>
<fractionDigits value=“29“ fixed=“false“/>
<minInclusivevalue=“−79228162514264337593543950335“/>
<maxInclusivevalue=“79228162514264337593543950335“/>

</restriction>

</simpleType>

TDL extended for ECMA maps some commonly used ECMA system types, charted in Table II, to existing XSD type as shown below Table II:

TABLE II

| | Schema | |
|---|---|---|
| ECMA Type | Type | Description |
| System.DateTime | ecma:dateTime | We derive from xsd:datetime |
| | | and place additional |
| | | restrictions that values |
| | | will be only in the range |
| | | 12:00:00 AM, 1/1/0001 CE |
| | | (Common Era) to 11:59:59 |
| | | PM, 12/31/9999 CE. We also |
| | | restrict the value set to |
| | | be based on UTC. |
| | | The dateTime value |
| | | would have to be output |
| | | in the canonical format |
| | | specified by xsd:datetime |
| | | CCYY-MM-DDThh:mm:ss |
| | | with no time zone. |
| System.Guid | ecma:guid | We derive from |
| | | xsd:hexBinary with a |
| | | restriction of |
| | | 128-bit length. |
| System.TimeSpan | ecma:timeSpan | We derive from |
| | | xsd:duration and place |
| | | additional restrictions |
| | | we express only in |
| | | terms of days and |
| | | hour, minute, second |
| | | + sign must never be |
| | | present |
| | | So the timeSpan value |
| | | [−][d.]hh:mm:ss[.ff] |
| | | should be output in |
| | | the canonical format |
| | | specified by xsd:timespan |
| | | [−]PnDThhHmmMssS. |
| | | Caveat: |
| | | xsd:duration does not |
| | | have a way for us to |
| | | place range restrictions |
| | | on the individual parts, |
| | | otherwise hours |
| | | should be in the range |
| | | (0-23); minutes |
| | | and seconds (0-59); |
| | | the fraction for seconds |
| | | should be 1-7 digits. |

ecma:guid
<simpleType name=“guid“>

<restriction base=“xsd:hexBinary“>

<length value=“16“ fixed=“true“/>

</restriction>

</simpleType>
ecma:dateTime
<simpleType name=“datetime“>

<restriction base=“xsd:datetime“>

<pattern value=‘\p{Nd} {4}−\p{Nd} {2}−\p{Nd}
{2}T\p{Nd} {2}:\p{Nd} {2}:\p{Nd}{2}’/>
<minInclusivevalue=“0001-1-1T0:00:00.0“/>
<maxInclusivevalue=“9999-12-31T23:59:59“/>

</restriction>

</simpleType>
ecma:timeSpan
<simpleType name=“timeSpan“>

<restriction base=“xsd:duration“>

<pattern value=‘\p(−)?\pP({Nd}+)?\p{Nd}
{2}H\p{Nd} {2}M\p{Nd} {2}(.{Nd} {1,7})?S’/>

</restriction>

</simpleTvpe>

With respect to Enum elements and fields, an ECMA Enum element has a name and value. Though the programming languages built on the ECMA type system may allow element name, or element name and value, to be defined, the ECMA type system is aware of the name, value pairs of the elements of the enumeration type. The data representation of an Enum type is completely covered by TDL's definition of an Enumeration. An ECMA Enum type does not have any behavioral aspect.

If the enum represents a bit field using the flags attribute, then the element names have associated bit position values. A bit field can be represented by TDL's definition of bit field.

An ECMA struct can be expressed in terms of its interfaces, members, modifiers and attributes. Members may be any one of the following types: constructor, event, field, method, nested type and properties.

Of the various members that an ECMA struct may include, constructors, methods, properties and nested types map to TDL action elements. The struct maps to the service TDL element. The base interfaces appear as elements of the implements section of the TDL service.

Fields contribute to the data aspect of an ECMA struct. Fields can be fully represented within TDL's definition of a struct.

With respect to classes, An ECMA class can be fully expressed in terms of its base class, interfaces, members, modifiers and attributes. Members can be one of the following types: constructor, event, field, method, nested type and properties.

Of the various members that an ECMA class may include, constructors, methods, properties and nested types map to TDL action elements. The class maps to the service TDL element. The base class is represented using the TDL extends element and interfaces appear as elements of the implements section of the TDL service. Fields and the base class contribute to the data aspect of an ECMA struct. These can be fully represented by TDL's definition of a class.

With respect to arrays, an ECMA array is fully described by its element type and the number of dimensions of the array. ECMA supports both rectangular and jagged arrays. An ECMA array can be represented using the TDL array definition.

With respect to interfaces, the interface section of TDL may represent an ECMA interface. The base interfaces of an ECMA interface appear as elements of the extends section of a TDL interface.

With respect to properties, ECMA properties are described by their name, type and allowed access. A property does not have any data representation. The TDL property element may represent the property.

With respect to constructors and methods, an ECMA constructor is fully described by its name and parameters. An ECMA method is fully described by its name, parameters and return type. Constructors and methods may be treated identically with the restriction that the constructor be named the same as the service.

The method element of TDL may represent an ECMA method or constructor. The parameters and return value of the method are represented in the TDL types section. The exceptions thrown by an ECMA method are also represented in the TDL type section. TDL extended for ECMA defines a base exception complex type in ecma namespace for use by system and custom exception types, as follows:

<complexType name=”exception” abstract=”true”/>

If an ECMA method has the attribute [OneWayAttribute=true], then it maps to the oneWayMethod element of TDL.

With respect to delegates, ECMA delegates are described by their name and method type. Delegates may be multicast delegates. Delegates are represented using the TDL method syntax.

ECMA delegates are represented using the ActionsElement substitution group of TDL as follows:

<complexType name=”delegate name”>

<complexContent>

<extension base=”tdl:method”>

<all>

<element name=”multicast” type=”xsd:boolean”/>

</all>

</extension>

</complexContent>

</complexType>
<element name=”delegate” type=”tns:delegate”

substitutionGroup=”tdl:ActionsElement”/>

In other words, the delegate element appears as a sibling to the Service and Interface elements within the Actions section of the TDL document.

For example, an ECMA delegate such as the following:

delegate void EventHandler(object sender, EventArgs e);

may be represented by the following with TDL extended for ECMA:

<delegate>

<name>EventHandler</name>
<in>tns:EventHandler</in>
<out>tns:EventHandlerResponse</out>
<multicast>false</multicast>

</delegate>

With respect to events, ECMA events are described by their delegate type. ECMA events are represented using the event substitution group of TDL, as illustrated by the following pseudocode:

<complexType name=”event name”>

<all>

<element name=”name” type=”string”/>
<element name=”delegate” type=”qname”/>

</all>

</complexType>
<element name=”ecmaEvent” type=”tns:event”
substitutionGroup=”tdl:event”/>

For example, an ECMA event such as:

public event AlarmEventHandler Alarm;

may be represented as the following with TDL extended for ECMA:

<ecmaEvent>

<name>Alarm</name>
<delegate>tns:AlarmEventHandler</delegate>

</ecmaEvent>

The following process achieves the support of overloading of ECMA methods: First, a unique name is generated for the method, which unique name is used as the name element in the TDL method. Then, the TDL convention of obtaining names for the in, out and fault composite types is followed using the unique name rather than the method name. Next, the original ECMA name is specified as an attribute in the TDL method specification. Then, an originalName global attribute is defined in the ecma namespace to allow this, as follows:

<attribute name=”originalName” type=”xsd: string” form=”qualified”/>

This solution is illustrated with the following exemplary pseudocode considering two methods with the same name:

string GetWord (int count) { . . . }

string GetWord (string anagram) { . . . }

The parameter types of the two methods are represented as follows:

<complexType name=”GetWord1”>

<all>

<element name=”count” type=”int”/>

</all>

</complexType>
<complexType name=”GetWordResponse1”>

<all>

<element name=”result” type=”string”/>

</all>

</complexType>
<complexType name=”GetWord2”>

<all>

<element name=”anagram” type=”string”/>

</all>

</complexType>
<complexType name=”GetWordResponse2”>

<all>

<element name=”result” type=”string”/>

</all>

</complexType>

and the methods are defined as follows:

<tdl:method ecma:originaName=^{:}”GetWord”>

<tdl:name>GetWord1</tdl:name>
<tdl:in>ttns:GetWord1</tdl:in> ?
<tdl:out>ttns:GetWord1Response</tdl:out>?

</tdl:method>
<tdl:method ecma:originaName=”GetWord”>

<tdl:name>GetWord2</tdl:name>
<tdl:in>ttns:GetWord2</tdl:in> ?
<tdl:out>ttns:GetWord2Response</tdl:out>?

</tdl:method>

In this example, the suffixes 1 and 2, where utilized, are indicative of the unique strings that may be appended to the method name.

An ECMA modifier describes additional characteristics of a type. A modifier is defined as a global attribute in the ecma namespace. The following is a list of ECMA defined modifiers:

<simpleType name=“accessModType“>

<restriction base=“string“>

<enumeration value=“private“/>
<enumeration value=“family“/>
<enumeration value=“assembly“/>
<enumeration value=“familyAndAssembly“/>
<enumeration value=“familyOrAssembly“/>
<enumeration value=“public“/>

</restriction>

</simpleType>
<simpleType name=“concretenessModType“>

<restriction base=“string“>

<enumeration value=“none“/>
<enumeration value=“abstract“/>
<enumeration value=“sealed“/>

</restriction>

</simpleType>
<simpleType name=“scopeModType“>

<restriction base=“string“>

<enumeration value=“none“/>
<enumeration value=“static“/>
<enumeration value=“virtual“/>

</restriction>

</simpleType>

<attribute name=”accessModifier” type=”ecma:accessModtype”

form=”qualified” default=”public”/>

<attribute name=”concretenessModifier” type=
”ecma:concretenessModType”

form=”qualified” default=”none”/>

<attribute name=”scopeModifier” type=”ecma:scopeModtype”

form=”qualified” default=”none”/>

The following is a list of the independent attribute values:

<attribute name=“newslot“ type=”xsd:boolean”

form=”qualified”default=”false”/>

<attribute name=“override“ type=”xsd:boolean”

form=”qualified”default=”false”/>

<attribute name=“initialize-only“ type=”xsd:boolean”

form=”qualified”default=”false”/>

...

With respect to the use of modifiers, while creating the type description, a developer may find it useful to indicate the level of exposure desired. For example, while describing a service's actions, the service developer might be interested in indicating the access scope of a method, as the following example illustrates:

<method ecma:accessModifier=”public”>

<name>GetGuide</name>
<in>ctns:GetGuide</in>
<out>ctns:GetGuideResponse</out>

</method>

With respect to attributes, ECMA attribute instances indicate one or more characteristics of a type element. ECMA attributes are also types.

TDL handles the flags attribute, SOAP:Embedded attribute and OneWay attribute in the following ways: The Flags attribute is handled to deduce that an enum is a bit field type. The SOAP:Embedded attribute is handled to indicate that a class or a field which is normally multi-reference type is to be treated as a single-reference type. The OneWay attribute is handled to deduce that a method is one-way.

All other ECMA attributes may be represented as complex types. Attributes specified on types, fields, parameters etc. are instance values of these complex types. The TDL values section is used to store these instance values and refer to them in the definitions of types, methods, fields, etc.

To support such referencing of attribute instances in various TDL and schema elements, a global attribute is defined in the ecma namespace as follows:

<attribute name=”attributeInstance” type=”xsd:string” form=”qualified”/>

For instance, for the following pseudocode:

[StructLayoutAttribute (Layout=Sequentia1)] struct AA { . . . };

the types schema namespace includes the following definition for struct AA and the StructLayoutAttribute as follows:

<complexType name=“AA“ ecma:attributeInstance=”#structLayoutAA”/>

<all .../>

</complexType>
<complexTypename=“StructLayoutAttribute“>

<all>

<element name=”Layout” type=”string”/>

</all>

</complexType>
<element name=”StructLayoutAttribute” type=”tns:StructLayoutAttribute”

substitutionGroup=”tdl:AnyValueElement”/>

and the TDL values section includes the value of the attribute as follows:

<values>

<StructLayoutAttributeid=”structLayoutAA”>

<Layout>sequential</Layout>

</StructLayoutAttribute>

</values>

An ECMA namespace maps onto a TDL namespace. For instance, the following namespace:

namespace Devices.Sony { . . . }

yields the following mapped namespace:

<TDL targetNamespace=
”http://www.sony.com/NSAssem/Devices.Sony/SonyAssembly”

.../>

Since ECMA types, like classes, may include nested type definitions, multiple TDL namespaces are used to maintain scoping of names. The TDL documents and schema namespaces may be nested within an outer TDL document or they may occur as independent documents. In this sense, TDL documents are modular. The important point is that the namespace names are unique.

With respect to TDL namespaces, based on the above, the following rules are applied while creating TDL and schema namespace names. The use of ecma as a prefix is reserved for special tokens that occur in the target namespace names. First, an ECMA namespace name is translated to a TDL namespace name of the form:

”http://<Any text>/NSAssem/<Ecma Namespace>/<Ecma Assembly>”

Second, a class name is translated to a TDL namespace name of the form:

http://<Any text>/NSAssem/<Ecma Namespace>/<Ecma Assembly>/EcmaNested/<Class
Name>/<ClassName>/...

In other words, the entire nesting class hierarchy is represented after EcmaNested.

The following example illustrates nested types. In the example, there are two nested types with the same name CC in two different classes BB and DD.

e.g. namespace xx.yy {

class AA {

class BB {

class CC {
};

};
class DD {

class CC {
};

};
interface EE;

};

}
<TDL targetnamespace=”http://www.mydomain.com/NSAssem/xx.yy/MyAssembly”>

<service><name>AA</name>...</service>
<schema targetnamespace=
”http://www.mydomain.com/NSAssem/xx.yy/MyAssembly”>

<complexType name=”AA”.../>

</schema>
<TDL targetnamespace=
”http://www.mydomain.com/NSAssem/xx.yy/MyAssembly/EcmaNested/AA”>

<service><name>BB</name>...</service>
<service><name>DD</name>...</service>
<interface><name>EE</name>...</interface>
<schema targetnamespace=
”http://www.mydomain.com/NSAssem/xx.yy/MyAssembly”

xmlns:bb=

”http://www.mydomain.com/NSAssem/xx.yy/MyAssembly/EcmaNested/AA/BB”

xmlns:dd=

”http://www.mydomain.com/NSAssem/xx.yy/MyAssembly/EcmaNested/AA/DD”>

<complexType name=”BB”.../>
<complexType name=”DD”.../>

</schema>

</TDL>
<TDL targetnamespace=
”http://www.mydomain.com/NSAssem/xx.yy/MyAssembly/EcmaNested/AA/BB”>

<service><name>CC</name>...</service>
<schema targetnamespace=
”http://www.mydomain.com/NSAssem/xx.yy/MyAssembly/EcmaNested/AA/BB”>

<complexType name=”CC”.../>

</schema>

</TDL>
<TDL targetnamespace=
”http://www.mydomain.com/NSAssem/xx.yy/MyAssenibly/EcmaNested/AA/DD”>

<service><name>CC</name>...</service>
<schema targetnamespace=
”http://www.mydomain.com/NSAssem/xx.yy/MyAssembly/EcmaNested/AA/DD”>

<complexType name=”CC”.../>

</schema>

</TDL>

</TDL>

Then, the CC types may be accessed using qnames “bb:CC” and “dd:CC”.

As mentioned above, while exemplary embodiments of the present invention have been described in connection with various computing devices and network architectures, the underlying concepts may be applied to any computing device or system in which it is desirable to define interfaces or services between devices or objects across a network, wherein the devices or objects may know nothing about one another beforehand. Thus, the techniques for mapping between types and schema in accordance with the present invention may be applied to a variety of applications and devices. For instance, TDL generation and parsing capabilities may be applied to the operating system of a computing device, provided as a separate object on the device, as part of the object itself, as a downloadable object from a server, as a “middle man” between a device or object and the network, etc. The TDL data generated may be stored for later use, or output to another independent, dependent or related process or service. While exemplary programming languages, names and examples are chosen herein as representative of various choices, these languages, names and examples are not intended to be limiting. One of ordinary skill in the art will recognize that such languages, names and examples are choices that may vary depending upon which type system is implicated, and the rules for the type system. Further while particular names for software components are utilized herein for distinguishing purposes, any name would be suitable and the present invention does not lie in the particular nomenclature utilized.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the histogram of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the histogram capabilities as described in exemplary embodiments above becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary embodiments of the invention are described in the context of a loosely coupled peer to peer network, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for describing a service of a device or object in a computing system, comprising:
describing the service with an extensible markup language (XML)-based Interface Description Language (IDL) that one to one maps a type of a particular type-based system to an XML schema and vice versa.

2. A method according to claim 1, wherein the XML-based IDL is Type Description Language (TDL).

3. A method according to claim 2, wherein TDL enables a one to one mapping from a programming construct to an XML schema for describing the programming construct and vice versa.

4. A method according to claim 3, wherein the programming construct is one of a pointer programming construct, primitive type programming construct, struct programming construct, class programming construct, array programming construct, subtype programming construct, enumeration type programming construct, service reference construct and bit field programming construct.

5. A method according to claim 2, wherein TDL enables a one to one mapping from a constant value of complex type to an XML schema for describing the constant value of complex type and vice versa.

6. A method according to claim 2, wherein TDL enables a one to one mapping from at least one of properties, methods and events of the type system to an XML schema for describing the at least one of properties, methods and events and vice versa.

7. A method according to claim 3, wherein TDL supports inheritance of programming constructs.

8. A method according to claim 1, wherein the XML-based IDL is the wire format for message communications relating to the service between devices of the computing system.

9. A method according to claim 8, wherein the XML-based IDL enables a one to one mapping from the wire format to the message communications and vice versa.

10. A method according to claim 2, wherein TDL enables the transfer of a service reference across an application boundary.

11. A method according to claim 1, wherein the computing system is a peer to peer distributed computing environment.

12. A method according to claim 1, wherein the XML-based IDL is extendable to map additional constructs of a richer type system to an XML schema and vice versa.

13. A computer readable medium having stored thereon a plurality of computer-executable instructions for performing the method of claim 1.

14. A modulated data signal carrying computer executable instructions for performing the method of claim 1.

15. A computing device comprising means for performing the method of claim 1.

16. A computer readable medium having stored thereon a plurality of computer-executable modules, the computer executable modules, comprising:
a mapping mechanism for describing a service of one of a device and object in a computing system with an extensible markup language (XML)-based Interface Description Language (IDL) that one to one maps a type of a particular type-based system to an XML schema and vice versa.

17. A computer readable medium according to claim 16, wherein the XML-based IDL is Type Description Language (TDL).

18. A computer readable medium according to claim 17, wherein TDL enables a one to one mapping from a programming construct to an XML schema for describing the programming construct and vice versa.

19. A computer readable medium according to claim 18, wherein the programming construct is one of a pointer programming construct, primitive type programming construct, struct programming construct, class programming construct, array programming construct, subtype programming construct, enumeration type programming construct, service reference construct and bit field programming construct.

20. A computer readable medium according to claim 17, wherein TDL enables a one to one mapping from a constant value of complex type to an XML schema for describing the constant value of complex type and vice versa.

21. A computer readable medium according to claim 17, wherein TDL enables a one to one mapping from at least one of properties, methods and events of the type system to an XML schema for describing the at least one of properties, methods and events and vice versa.

22. A computer readable medium according to claim 18, wherein TDL supports inheritance of programming constructs.

23. A computer readable medium according to claim 16, wherein the XML-based IDL is the wire format of message communications relating to the service between devices of the computing system.

24. A computer readable medium according to claim 23, wherein the XML-based IDL enables a one to one mapping from the wire format to the message communications and vice versa.

25. A computer readable medium according to claim 17, wherein TDL enables the transfer of a service reference across an application boundary.

26. A computer readable medium according to claim 16, wherein the computing system is a peer to peer distributed computing environment.

27. A computer readable medium according to claim 16, wherein the mapping mechanism for the XML-based IDL is extendable to map additional constructs of a richer type system to an XML schema and vice versa.

28. A modulated data signal carrying computer executable instructions output as a result of the execution of the plurality of computer-executable instructions of the computer readable medium of claim 16.

29. A computing device comprising means for carrying out the plurality of computer-executable instructions of the computer readable medium of claim 16.

30. A computing device, comprising:
an operating system, stored as computer-executable instructions on a computer readable medium, the computer-executable instructions of the operating system comprising:
a mapping mechanism for describing a service of one of a device and object in a computing system with an extensible markup language (XML)-based Interface Description Language (IDL) that one to one maps a type of a particular type-based system to an XML schema and vice versa.

31. A computing device according to claim 30, wherein the XML-based IDL is Type Description Language (TDL).

32. A computing device according to claim 31, wherein TDL enables a one to one mapping from a programming construct to an XML schema for describing the programming construct and vice versa.

33. A computing device according to claim 32, wherein the programming construct is one of a pointer programming construct, primitive type programming construct, struct programming construct, class programming construct, array programming construct, subtype programming construct, enumeration type programming construct, service reference construct and bit field programming construct.

34. A computing device according to claim 31, wherein TDL enables a one to one mapping from a constant value of complex type to an XML schema for describing the constant value of complex type and vice versa.

35. A computing device according to claim 31, wherein TDL enables a one to one mapping from at least one of properties, methods and events of the type system to an XML schema for describing the at least one of properties, methods and events and vice versa.

36. A computing device according to claim 32, wherein TDL supports inheritance of programming constructs.

37. A computing device according to claim 30, wherein the XML-based IDL is the wire format of message communications relating to the service between devices of the computing system.

38. A computing device according to claim 37, wherein the XML-based IDL enables a one to one mapping from the wire format to the message communications and vice versa.

39. A computing device according to claim 31, wherein TDL enables the transfer of a service reference across an application boundary.

40. A computing device according to claim 30, wherein the computing system is a peer to peer distributed computing environment.

41. A computing device according to claim 30, wherein the mapping mechanism for the XML-based IDL is extendable to map additional constructs of a richer type system to an XML schema and vice versa.
